(19) United States
(12) Patent Application Publication
(10) Pub. No.: US 2024/0416678 A1
(43) Pub. Date: Dec. 19, 2024

(54) VEHICULAR WHEEL BEARING COMPRISING SEALING DEVICE HAVING INTERNAL PRESSURE DISCHARGING PORTION

(71) Applicant: ILJIN GLOBAL Co.,Ltd, Seoul (KR)

(72) Inventor: Jong Keun LIM, Seoul (KR)

(73) Assignee: ILJIN GLOBAL Co.,Ltd, Seoul (KR)

(21) Appl. No.: 18/742,997

(22) Filed: Jun. 13, 2024

(30) Foreign Application Priority Data
Jun. 13, 2023 (KR) 10-2023-0075854

(51) Int. Cl. B60B 27/00

(52) U.S. Cl. CPC B60B 27/0073; B60B 27/001; B60B 27/0078

(57) ABSTRACT

According to one embodiment, provided is a vehicular wheel bearing for rotatably mounting and supporting a vehicular wheel on a vehicle body. The vehicular wheel bearing includes a rotating element which rotates together with the vehicular wheel; a non-rotating element mounted and fixed to the vehicle body; a plurality of rolling elements disposed between the rotating element and the non-rotating element; and a sealing device installed between the rotating element and the non-rotating element to prevent an inflow of external foreign substances. The sealing device includes a first member mounted to either the rotating element or the non-rotating element of the wheel bearing; a second member mounted to the other one of the rotating element and the non-rotating element of the wheel bearing; and a negative pressure prevention member attached to the first member.

### CROSS-REFERENCE TO RELATED APPLICATION

This application claims priority to Korean Patent Application No. 10-2023-0075854 filed on Jun. 13, 2023, the entire contents of which are herein incorporated by reference.

### TECHNICAL FIELD

The present disclosure relates to a vehicular wheel bearing for rotatably mounting and supporting a vehicular wheel on a vehicle body, and more particularly, to a vehicular wheel bearing configured to prevent high internal pressure from forming in a bearing space portion at the time of installing a sealing device by forming an internal pressure discharging structure in the sealing device.

### DESCRIPTION OF THE RELATED ART

A wheel bearing is a device used for rotatably mounting and supporting a vehicular wheel on a vehicle body, and performs a function of rotatably supporting a wheel mounted to a rotating element to a vehicle body by connecting the rotating element, to which the wheel is mounted, to a non-rotating element fixed to the vehicle body through rolling elements.

On the other hand, since the wheel bearing is easily exposed to external foreign substances such as mud, moisture, or the like due to the nature of the product used by being mounted to the vehicular wheel, the wheel bearing comprises a sealing device which prevents foreign substances from entering the insides of the wheel bearing.

Referring to FIG. 1, a structure of a vehicular wheel bearing comprising a sealing device is exemplarily shown.

As shown in FIG. 1, a vehicular wheel bearing 10 is configured so that a rotating element (20; for example, wheel hub and inner ring), to which a vehicular wheel is mounted, is rotatably mounted to a non-rotating element (30; for example, outer ring) fixed to a vehicle body through rolling elements 40. In addition, the vehicular wheel bearing 10 is configured so that a sealing device(s) 50 is provided between the rotating element 20 and the non-rotating element 30 to prevent an inflow of external foreign substances or leakage of internal grease.

Referring to FIG. 2, a sealing device [50; inboard-side sealing device (sealing device shown in part A of FIG. 1)] with a pack sealing structure which may be used for the vehicular wheel bearing 10 is shown as an example.

As shown in FIG. 2, the sealing device 50 may comprise an outer part 60 located on an outer side in a radial direction and an inner part 70 located on an inner side in the radial direction. In addition, the sealing device 50 is configured so that at least one of the outer part 60 and the inner part 70 comprises an elastic sealing portion 62, and a sealing lip 64 provided in an elastic sealing portion 62 is in contact with or disposed adjacent to a counterpart member and thus they perform sealing.

Incidentally, such a sealing device 50 may increase internal pressure by pressurizing a bearing space portion (space portion in which rolling elements located) inside the wheel bearing during the process of press-fitting and installing it in the wheel bearing, and this increase in internal pressure of the bearing space portion may cause deterioration of the installing and sealing performance of the sealing device.

### DISCLOSURE OF THE INVENTION

### Technical Goals

The present disclosure is intended to solve the problems in the related art described above, and the present disclosure is for the purpose of providing a vehicular wheel bearing configured to prevent high internal pressure (negative pressure) form forming in a bearing space portion at the time of installing a sealing device by forming an internal pressure discharging structure in the sealing device.

### Technical Solutions

Representative configurations of the present disclosure to achieve the above-described purpose are as follows.

According to an example embodiment of the present disclosure, a vehicular wheel bearing for rotatably mounting and supporting a vehicular wheel on a vehicle body is provided. The vehicular wheel bearing according to an example embodiment of the present disclosure may comprise: a rotating element which rotates together with the vehicular wheel; a non-rotating element mounted and fixed to the vehicle body; a plurality of rolling elements disposed between the rotating element and the non-rotating element; and a sealing device 500 installed between the rotating element 200 and the non-rotating element 300 to prevent an inflow of external foreign substances. According to an example embodiment of the present disclosure, the sealing device comprises a first member mounted to either the rotating element or the non-rotating element of the wheel bearing; a second member mounted to the other one of the rotating element and the non-rotating element of the wheel bearing; and a negative pressure prevention member attached to the first member. According to an example embodiment of the present disclosure, the first member of the sealing device may comprise a through hole(s) which communicates with a sealing space portion formed inside the sealing device. According to an example embodiment of the present disclosure, the negative pressure prevention member may comprise an internal pressure discharging portion which communicates a bearing space portion, in which the rolling elements are located, with the sealing space portion, and the inner pressure discharge portion may be configured to communicate with the bearing space portion at a first position and to communicate with the sealing space portion via the through hole(s) at a second position apart from the first position.

According to an example embodiment of the present disclosure, the first position may be located further inward in a radial direction than the second position.

According to an example embodiment of the present disclosure, the first position may be located further outward in the radial direction than the second position.

According to an example embodiment of the present disclosure, at least one sealing lip may be provided on radially outer and radially inner sides of the second position, respectively.

According to an example embodiment of the present disclosure, a sealing lip located on the radially outer side of the second position may be a non-contact sealing lip.

According to an example embodiment of the present disclosure, the internal pressure discharging portion may be formed as a recessed structure in one axial end surface of the negative pressure prevention member.

According to an example embodiment of the present disclosure, the internal pressure discharging portion may comprise a plurality of segments extending in different directions to form a labyrinth structure.

According to an example embodiment of the present disclosure, a plurality of the internal pressure discharging portions may be provided in the negative pressure prevention member.

According to an example embodiment of the present disclosure, a vehicular wheel bearing for rotatably mounting and supporting a vehicular wheel to a vehicle body is provided. The vehicular wheel bearing according to an example embodiment of the present disclosure may comprises: a rotating element which rotates together with the vehicular wheel; a non-rotating element mounted and fixed to the vehicle body; a plurality of rolling elements disposed between the rotating element and the non-rotating element; and a sealing device installed between the rotating element and the non-rotating element to prevent an inflow of external foreign substances. According to an example embodiment of the present disclosure, the sealing device may comprise a first member mounted to either the rotating element or the non-rotating element of the wheel bearing; and a second member mounted to the other one of the rotating element and the non-rotating element of the wheel bearing. According to an example embodiment of the present disclosure, the first member of the sealing device may comprise an internal pressure discharging portion which communicates a sealing space portion formed inside the sealing device with a bearing space portion in which the rolling elements are located. According to an example embodiment of the present disclosure, the internal pressure discharging portion may be configured to communicate with the bearing space portion at a first position X and to communicate with the sealing space portion at a second position apart from the first position.

According to an example embodiment of the present disclosure, the first position may be located further inward in a radial direction than the second position.

According to an example embodiment of the present disclosure, the first position may be located further outward in a radial direction than the second position.

According to an example embodiment of the present disclosure, at least one sealing lip may be provided on radially outer and radially inner sides of the second position, respectively.

According to an example embodiment of the present disclosure, a sealing lip located on the radially outer side of the second position may be a non-contact sealing lip.

According to an example embodiment of the present disclosure, the internal pressure discharging portion may be formed as a recess structure on one axial end surface of a frame of the first member of the sealing device.

According to an example embodiment of the present disclosure, the internal pressure discharging portion may comprise a plurality of segments extending in different directions to form a labyrinth structure.

According to an example embodiment of the present disclosure, a plurality of the internal pressure discharging portions may be provided in the first member of the sealing device.

In addition, the vehicular wheel bearing according to the present disclosure may further comprise other additional configurations without departing from the technical sprit of the present disclosure.

### Effects

A vehicular wheel bearing according to an example embodiment of the present disclosure has a configuration in which an internal pressure discharging portion is provided on one side of a sealing device so that an internal pressure formed in a bearing space portion maybe discharged to the outside. Thus, at the time of installing the sealing device, it is possible to prevent highly rising of internal pressure in the bearing space portion. Therefore, due to this negative pressure prevention effect, it is possible to prevent the installing or sealing performance of the sealing device from deteriorating.

In addition, a vehicular wheel bearing according to an example embodiment of the present disclosure is configured so that the aforementioned internal pressure discharging portion communicates with a bearing space portion at a first position and communicates with a sealing space portion at a second position spaced apart from the first position. Thus, the pressure of the bearing space portion may be discharged to the outside through the internal pressure discharging portion, while preventing external foreign substances from entering the inside of the bearing space portion through the internal pressure discharging portion.

### BRIEF DESCRIPTION OF THE DRAWINGS

FIG. 1 exemplarily shows an example of a vehicular wheel bearing.

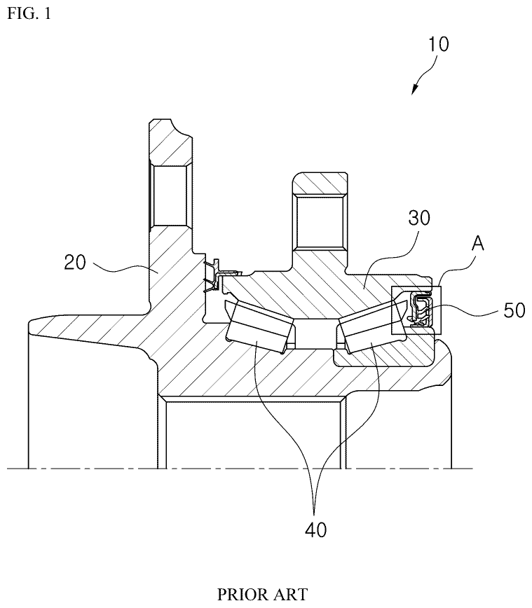

FIG. 2 exemplarily shows an example of a sealing device (for example, sealing device with a pack sealing structure) which may be used in a vehicular wheel bearing.

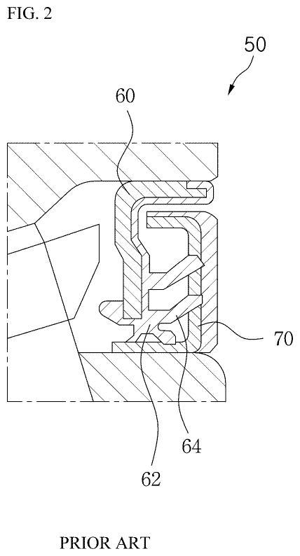

FIG. 3 exemplarily shows a structure of a vehicular wheel bearing according to an example embodiment of the present disclosure.

FIG. 4 exemplarily shows an example embodiment of a sealing device (inboard-side sealing device) which may be used in a vehicular wheel bearing according to an example embodiment of the present disclosure.

FIG. 5 exemplarily shows an example of a negative pressure prevention member which may be provided in a sealing device according to an example embodiment of the present disclosure.

FIG. 6 exemplarily shows a modified example of the negative pressure prevention member shown in FIG. 5.

FIG. 7 exemplarily shows a modified example of the sealing device (inboard-side sealing device) shown in FIG. 4.

FIG. 8 exemplarily shows another example embodiment of a sealing device (inboard-side sealing device) which may be used in a vehicular wheel bearing according to an example embodiment of the present disclosure.

FIG. 9 exemplarily shows a modified example of the sealing device shown in FIG. 8.

### DETAILED DESCRIPTION

Example embodiments of the present disclosure described herein are exemplified for the purpose of describing the technical spirit of the present disclosure. The scope of the claims according to the present disclosure is not limited to the example embodiments described below or to detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising,” “including,” “having,” and the like used herein should be construed as open-ended terms encompassing the possibility of including other example embodiments.

The term “axial direction” used herein may be defined as a direction extending along a rotational central axis of a wheel bearing. The term “radial direction” used herein may be defined as a direction perpendicular to the axial direction and away from the rotational central axis or approaching the rotational central axis. The term “circumferential direction” used herein may be defined as a direction rotating about the axial direction described above.

Unless the phrase or sentence clearly indicates otherwise, the expression “a constituent element extends in the axial direction or the radial direction” used herein should be understood as encompassing a case where the constituent element extends parallel to the axial direction or the radial direction as well as a case where the constituent element extends obliquely with respect to the axial direction or the radial direction.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, example embodiments of the present disclosure will be described in detail with reference to the accompanying drawings at such an extent that they may be readily practiced by those ordinary skilled in the art. In the accompanying drawings, the same reference numerals are assigned to the same or corresponding components. Furthermore, in the following descriptions of the example embodiments, duplicate descriptions of the same or corresponding constituent elements may be omitted. However, even though a description(s) of a constituent element is omitted, such a constituent element is not intended to be excluded in any example embodiment.

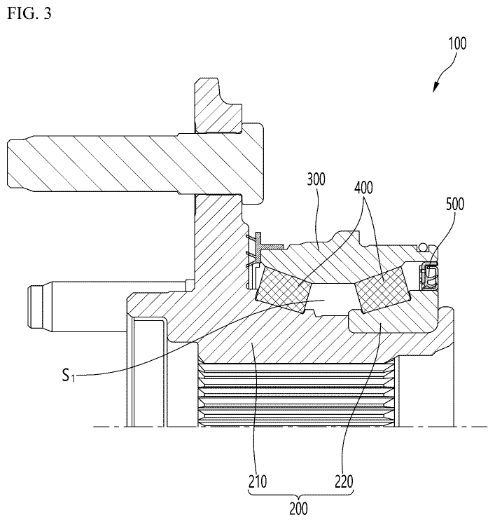

Referring to FIGS. 3 to 9, a vehicular wheel bearing according to an example embodiment of the present disclosure and a sealing device which may be applied to such a vehicular wheel bearing are shown as examples.

As shown in the drawings, a vehicular wheel bearing 100 according to an example embodiment of the present disclosure may be configured so that a rotating element [200; for example, wheel hub 210 and inner ring 220] rotating together with a vehicular wheel is connected to a non-rotating element (300; for example, outer ring) mounted and fixed to a vehicle body through a plurality of rolling elements 400, similar with a conventional vehicular wheel bearing.

According to an example embodiment of the present disclosure, the wheel hub 210 constituting the rotating element 200 may be formed into a substantially cylindrical shape extending in an axial direction, and a wheel mounting flange (hub flange) may be provided on an outer circumferential surface of the wheel hub 210. The wheel mounting flange is formed in a shape extending outward in a radial direction from the outer circumferential surface of the wheel hub 210 and may be used for mounting a vehicular wheel to the wheel hub 210 using hub bolts or the like. On the other hand, the inner ring 220 may be mounted to a vehicle-body-side end portion of the wheel hub 210 and a raceway (inner raceway) may be formed on a portion of the outer circumferential surface of the wheel hub 210 to support the rolling elements 400 from an inner side in the radial direction.

According to an example embodiment of the present disclosure, at least one inner ring 220 may be mounted on a circumferential surface of the wheel hub 210. According to an example embodiment of the present disclosure, the inner ring 220 may be configured so that the raceway (inner raceway) of the rolling elements is formed on the outer circumferential surface thereof to support the rolling elements 400 from the inner side in the radial direction. For example, the inner ring 220 may be configured to be press-fitted to a seating portion provided on the vehicle-body-side end portion of the wheel hub 210, and may be configured to be assembled on the wheel hub 210 with a predetermined preload applied.

According to an example embodiment of the present disclosure, the outer ring constituting the non-rotating element 300 may comprises, on an outer circumferential surface, a vehicle-body-side mounting flange using which the wheel bearing is mounted to the vehicle body. According to an example embodiment of the present disclosure, the outer ring may be configured to comprise, on an inner circumferential surface, a raceway (outer raceway) with which the rolling elements 400 is in contact. The raceway (outer raceway) formed on the inner circumferential surface of the outer ring may be configured to cooperate with the raceway (inner raceway) formed on the wheel hub 210 and/or the inner ring 220 to accommodate and support the rolling elements 400 between the raceways.

According to an example embodiment of the present disclosure, the rolling elements 400 are disposed between the rotating element 200 and the non-rotating element 300 of the wheel bearing 100, and may perform the function of rotatably supporting the rotating element 200 of the wheel bearing 100 with respect to the non-rotating element 300.

Here, the above-described configurations of the vehicular wheel bearing 100 according to an example embodiment of the present disclosure do not have to be limited to the structure shown in the drawings, and may be modified and formed into various structures which may be applied to vehicular wheel bearings.

For example, in the case of the example embodiment shown in the drawing, the vehicular wheel bearing 100 is configured such that a raceway for supporting the rolling elements 400 is directly formed on the outer circumferential surface of the wheel hub 210. However, the vehicular wheel bearing 100 according to an example embodiment of the present disclosure may be modified and implemented in other structures, such as a structure where two inner rings 220 are mounted to the wheel hub 210 and the rolling elements 400 are supported through the two inner rings 220.

Also, in the case of the example embodiment shown in the drawing, the rolling elements 400 which rotatably support the rotating element 200 of the wheel bearing 100 with respect to the non-rotating element 300 of the wheel bearing 100 are shown in the form of a tapered roller. However, the rolling elements 400 of the wheel bearing 100 may be formed of rolling elements of other shapes such as a spherical ball.

According to an example embodiment of the present disclosure, a sealing device 500 which prevents external foreign substances from entering a bearing space portion S₁, in which the rolling elements 400 are disposed, or prevents grease filled in the bearing space portion S₁ from leaking to the outside may be provided at an end portion(s) of the wheel bearing 100.

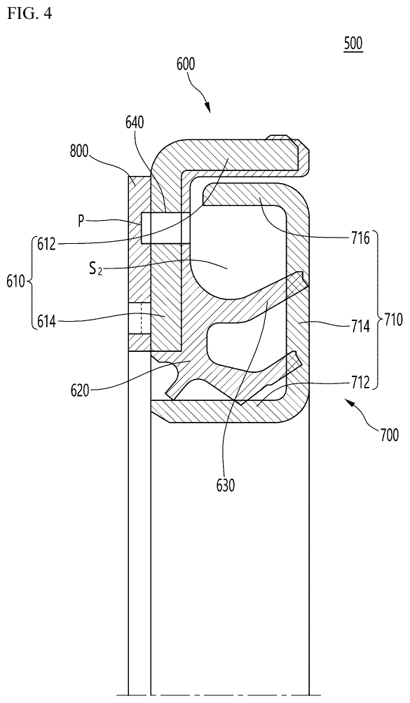

Referring to FIG. 4, a structure of the sealing device (in the case of the example shown in the drawing, inboard-side sealing device) which may be used for the vehicular wheel bearing 100 according to an example embodiment of the present disclosure is exemplarily shown.

According to an example embodiment of the present disclosure, the sealing device 500 may be configured to comprise a first member 600 mounted to either the rotating element 200 or the non-rotating element 300 of the wheel bearing 100; and a second member 700 mounted to the other one of the rotating element 200 and the non-rotating element 300 of the wheel bearing 100.

For example, in the case of the example embodiment shown in the drawing, the first member 600 of the sealing device 500 is configured to be press-fitted and mounted to the outer ring constituting the non-rotating element 300, the second member 700 of the sealing device 500 is configured to be press-fitted and mounted to the inner ring 220 constituting the rotating element 200, and the first member 600 is configured to be located closer to the bearing space portion S₁ than the second member 700.

According to an example embodiment of the present disclosure, the first member 600 and the second member 700 of the sealing device 500 are configured to comprise a frame [frame 610 of the first member 600 and frame 710 of the second member 700] forming a body and such a frame (frame 610 of the first member 600 and frame 710 of the second member 700) may be configured to be press-fitted and mounted to the rotating element 200 or the non-rotating element 300 of the wheel bearing 100.

According to an example embodiment of the present disclosure, the frame 610 of the first member 600 and the frame 710 of the second member 700 may be configured to comprise a press-fitting portion 612; 712 having a substantially cylindrical shape and a flange portion 614; 714 extending radially from the press-fitting portion 612; 712.

On the other hand, according to an example embodiment of the present disclosure, one or more of the frame 610 of the first member 600 and the frame 710 of the second member 700 may be configured to comprise a structure in which the end portion of the flange portion is bent to more effectively prevent the inflow of external foreign substances.

For example, in the case of the example embodiment shown in the drawing, the frame 710 of the second member 700 is configured to comprise a bent portion 716 that is bent from the flange portion 714 and extends in the axial direction. Wherein, the bent portion 716 may be configured to form a labyrinth structure between the bent portion 716 and the press-fit portion 612 of the frame 610 of the first member 600 to more effectively prevent the inflow of external foreign substances.

According to an example embodiment of the present disclosure, one or more of the first member 600 and the second member 700 of the sealing device 500 may comprise an elastic sealing portion 620 and may be configured to perform sealing through the elastic sealing portion 620.

For example, in the case of the example embodiment shown in the drawing, the first member 600 of the sealing device 500 is configured to comprise an elastic sealing portion 620 so that the elastic sealing portion 620 interacts with the second member 700 to perform sealing.

According to an example embodiment of the present disclosure, the elastic sealing portion 620 may be configured to surround all or a part of the frame 610 from the radially inner end portion of the frame 610 to the radially outer end portion of the frame 610.

According to an example embodiment of the present disclosure, the elastic sealing portion 620 may be configured to comprise at least one sealing lips 630 so that the end of the sealing lip 630 is in contact with or disposed adjacent to a counterpart member to perform sealing.

For example, in the case of the example embodiment shown in the drawing, the sealing device 500 is formed in a structure in which the elastic sealing portion 620 provided in the first member 600 comprises a plurality of sealing lips [630; a side lip which is in contact with and performs sealing together with the flange portion 714 of the frame 710 of the second member 700, a grease lip which is disposed on the innermost side to prevent leakage of grease filled in the bearing space S₁, or the like].

According to an example embodiment of the present disclosure, the first member (600; for example, member disposed adjacent to the bearing space portion) of the sealing device 500 may be configured to comprise a through hole(s) 640 communicating with the sealing space portion S₂ formed inside the sealing device 500.

According to an example embodiment of the present disclosure, the through hole 640 may be configured to be formed in the flange portion of the first member 600. In addition, when the first member 600 of the sealing device 500 comprises an elastic sealing portion 620 as shown in the drawing, the frame 610 of the first member 600 and the elastic sealing portion 620 may be formed to penetrate together.

According to an example embodiment of the present disclosure, the sealing device 500 may be configured to further comprise a negative pressure prevention member 800 attached to the first member 600 (a member disposed adjacent to the bearing space portion).

According to an example embodiment of the present disclosure, the negative pressure prevention member 800 is configured to communicate the bearing space portion S₁ with the sealing space portion S₂ so that the pressure of the bearing space portion S₁ may be discharged to the outside at the time of installing the sealing device 500. Thus, the negative pressure prevention member 800 may perform the function of preventing high internal pressure from being formed in the bearing space portion S₁.

According to an example embodiment of the present disclosure, the negative pressure prevention member 800 may be formed in a substantially ring-shaped structure as shown in the drawing, and may be configured to comprise an internal pressure discharging portion P on one side of the negative pressure prevention member 800.

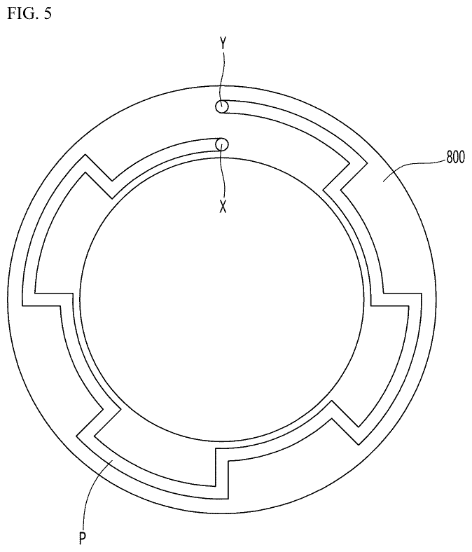

According to an example embodiment of the present disclosure, the internal pressure discharging portion P may be configured to be formed as a recess structure in one axial end surface of the negative pressure prevention member 800, as shown in FIGS. 4 and 5.

According to an example embodiment of the present disclosure, the internal pressure discharging portion P may be configured to communicate with the bearing space portion S₁ at a the first position X and to communicate with the through hole 640 at a second position Y spaced apart from the first position X.

According to this structure, the air in the bearing space portion S₁ may flow into the internal pressure discharging portion P of the negative pressure prevention member 800 at the first position X and the air flowing into the internal pressure discharging portion P can be discharged from the second position Y to the sealing space portion S₂.

Therefore, in the vehicular wheel bearing 100 according to an example embodiment of the present disclosure, when the sealing device 500 is press-fitted and installed, even when the bearing space portion S₁ is pressurized by the sealing device 500, the increased pressure of the bearing space portion S₁ may be discharged through the internal pressure discharging portion P. Thus, it is possible to prevent deterioration of the installation and/or sealing performance of the sealing device 500 which may be caused by an increase in the pressure of the bearing space portion S₁.

According to an example embodiment of the present disclosure, the internal pressure discharging portion P can be formed into a structure in which the internal pressure discharging portion P communicates only with the bearing space portion S₁ and does not communicate with the sealing space portion S₂ at the first position and communicates only with the sealing space portion S₂ and does not communicate with the bearing space portion S₁ at the second position Y.

According to an example embodiment of the present disclosure, the internal pressure discharging portion P may be configured to extend in various directions such as a radial direction, a circumferential direction, and/or a direction inclined thereto.

According to an example embodiment of the present disclosure, the internal pressure discharging portion P may be composed of a plurality of segments extending in different directions to form a long and narrow labyrinth structure in the negative pressure prevention member 800.

For example, in the case of the example embodiment shown in the drawing, the internal pressure discharging portion P of the labyrinth structure is formed in the negative pressure prevention member 800 by combining the segments extending in the circumferential direction and the segments extending in the radial direction.

According to the above-described structure, the pressure in the bearing space portion S₁ may be discharged to the outside through the through hole 640 provided in the first member 600 of the sealing device 500 and the internal pressure discharging portion P connected thereto, and at the same time, foreign substances introduced into the sealing device 500 may be prevented from entering the inside of the bearing space portion S₁ through the internal pressure discharging portion P.

According to an example embodiment of the present disclosure, a negative pressure prevention member 800 may be formed of a material such as plastic and may be formed using a method such as injection molding.

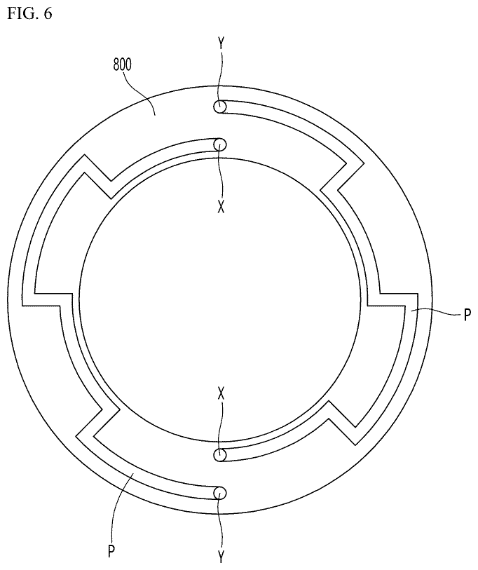

According to an example embodiment of the present disclosure, the internal pressure discharging portion P may be formed as one continuous structure as shown in FIG. 5 or a plurality of internal pressure discharging portions P spaced apart from each other may be provided as shown in FIG. 6.

According to an example embodiment of the present disclosure, the first position X communicating with the bearing space portion S₁ and the second position Y communicating with the sealing space portion S₂ may be configured to be provided at positions spaced apart in the radial and/or circumferential directions.

For example, in the case of the example embodiment shown in FIGS. 3 to 6, the first position X is configured to be located further inward in the radial direction than the second position Y and the first position X is configured to be spaced apart from the second position Y in the radial direction.

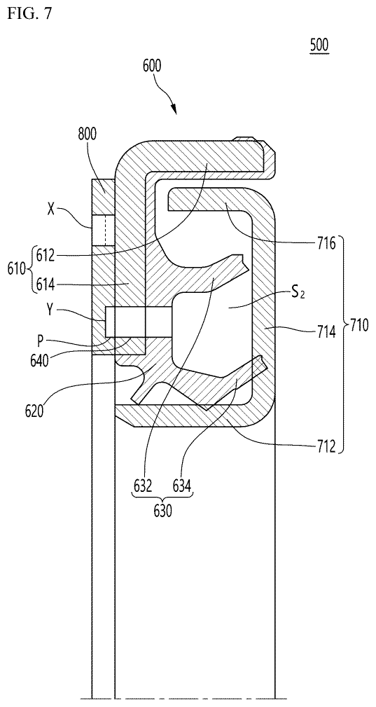

On the other hand, the first position X communicating with the bearing space port S₁ may be configured to be located further outward in the radial direction than the second position Y communicating with the sealing space portion S₂ as shown in FIG. 7.

According to an example embodiment of the present disclosure, as shown in FIG. 7, the sealing device 500 may be configured to comprise at least one sealing lip 632, 634 on the radially outer and radially inner sides of the second position Y in communication with the sealing space portion S₂, respectively.

As shown in FIG. 7, when a sealing lip(s) 632 is provided on the radial outer side of the second position Y in communication with the sealing space portion S₂, such a sealing lip 632 can prevent external foreign substances from entering the inside of the second position Y part. Thus, it is possible to further prevent external foreign substances from entering the inside of the bearing space portion S₁ in which the rolling elements 400 is located.

According to an example embodiment of the present disclosure, in the case of an example embodiment comprising the sealing lip 632 on the radially outer side of the second position Y as shown in FIG. 7, it may be preferable that the sealing lip 632 located further outward in the radial direction than the second position Y is formed as a non-contact sealing lip not to interrupt the escape of the internal pressure discharged to the sealing space portion S₂ or is formed as a contact-type sealing lip with a relatively small amount of interference compared to the sealing lip 634 located on the radial inner side.

On the other hand, in the case of the example embodiment shown in the drawing, although the internal pressure discharging portion P is configured to start at the first position X and end at the second position Y, the internal pressure discharging portion P is not necessarily limited to this structure. Alternatively, the first position X communicating with the bearing space portion S₁ and/or the second position Y communicating with the sealing space portion S₂ may be configured to be formed in the middle portion of the international press discharge portion P.

According to an example embodiment of the present disclosure, the internal pressure discharging portion P may be formed to have the same depth and may be formed to have a penetrating structure only at the first position X, as shown in the drawing.

However, the shape of the internal pressure discharging portion P does not need to be limited to the above-described structure. Alternatively, the internal pressure discharging portion P may be formed in a structure whose depth varies in accordance with the position or may be formed to have a communication hole formed inside the negative pressure prevention member 800 instead of a recess structure open on one side.

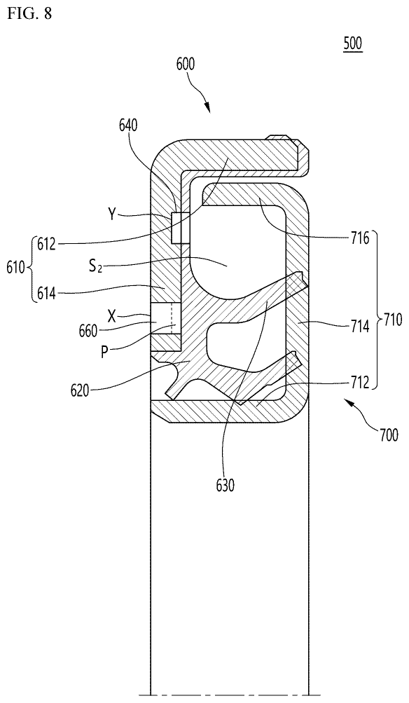

Next, referring to FIG. 8, another example embodiment of the sealing device 500 which may be used in the vehicular wheel bearing 100 according to an example embodiment of the present disclosure is exemplarily shown.

The sealing device 500 shown in FIG. 8 may be formed to have an overall identical/similar structure to the sealing device 500 described above in relation to FIGS. 3 to 7. In addition, the only difference is that the internal pressure discharging portion P is formed directly in the first member 600 of the sealing device 500 without using the negative pressure prevention member 800.

Specifically, like the previous example embodiment, the sealing device 500 of the example embodiment shown in FIG. 8 may be configured to comprise the first member 600 mounted to either the rotating element 200 or the non-rotating element 300 of the wheel bearing 100; and the second member 700 mounted to the other one of the rotating element 200 and the non-rotating element 300 of the wheel bearing 100. In addition, the first member 600 of the sealing device 500 may be configured to comprise the internal pressure discharging portion P which communicates the sealing space portion S₂ formed inside the sealing device 500 with the bearing space portion S₁ in which the rolling elements 400 are located.

According to an example embodiment of the present disclosure, the internal pressure discharging portion P provided in the first member 600 of the sealing device 500 may be formed in substantially the same manner as the internal pressure discharging portion P formed in the negative pressure prevention member 800 of the previous example embodiment.

For example, the internal pressure discharging portion P provided in the first member 600 of the sealing device 500 may be formed as a recessed structure in one axial end surface of the frame 610 of the first member 600 of the sealing device 500, as shown in FIG. 8 and may be configured to communicate with the bearing space port S₁ at a first location X and to communicate with the sealing space portion S₂ at a second location Y apart from the first location X.

According to an example embodiment of the present disclosure, in the internal pressure discharging portion P provided in the first member 600 of the sealing device 500, the first position X and the second position Y may be configured to be provided at positions spaced apart in the radial direction and/or the circumferential direction, similar to the previous example embodiment, and the internal pressure discharge portion P may be configured to extend in various directions such as in a radial direction, in a circumferential direction, and/or in a direction inclined thereto.

According to an example embodiment of the present disclosure, the internal pressure discharging portion P provided in the first member 600 of the sealing device 500 may be composed of a plurality of segments extending in different directions, similar to the previous example embodiment and may be configured to form a long and narrow labyrinth structure in the first member 600.

According to an example embodiment of the present disclosure, the internal pressure discharging portion P provided in the first member 600 of the sealing device 500 is formed in a structure in which the internal pressure discharging portion P communicates only with the bearing space portion S₁ and does not communicate with the sealing space portion S₂ at the first position and communicates only with the sealing space portion S₂ and does not communicate with the bearing space portion S₁ at the second position Y. In addition, the internal pressure discharging portion P provided in the first member 600 of the sealing device 500 may be configured so that the internal pressure discharging portion P is not in direct communication with the bearing space portion S₁ and the sealing space portion S₂, but is in communication via the internal pressure discharging portion P of the labyrinth structure provided in the first member 600.

For example, in the case of the example embodiment shown in FIG. 8, the first member 600 of the sealing device 500 has a through hole(s) 650 in the frame 610 at a first position X, such that the internal press discharge portion P communicates with the bearing space portion S₁ via the through hole 650 whereas the sealing space portion S₂ side is configured to be closed using the elastic sealing portion 620. In addition, the first member 600 of the sealing device 500 has a recess portion 660 which is opened toward the sealing space portion S₂ [for example, a recess structure formed by combining a recess provided in the frame 610 of the first member 600 and a through hole provided in the elastic sealing portion 620] at the second position Y, such that the bearing space portion S₁ side is closed by the bottom surface of the recess portion 660 whereas the internal press discharge portion P communicates with the sealing space portion S₂ through an opening in the recess portion 660.

According to this structure, similar to the previous example embodiment, the air in the bearing space portion S₁ may flow into the internal pressure discharging portion P formed in the first member 600 of the sealing device 500 at the first position and the air flowing into the internal pressure discharging portion P may be discharged from the second position Y to the sealing space portion S₂.

Therefore, similar to the previous example embodiment, the vehicular wheel bearing 100 shown in FIG. 8 may prevent the deterioration of the installing and/or sealing performance of the sealing device 500 due to an increase in pressure in the bearing space portion S₁ which occurs during the press-fitting process of the sealing device 500.

Also, since the first position X which communicates with the bearing space portion S₁ and the second position Y which communicates with the sealing space portion S₂ are located apart from each other, it is possible to prevent the inflow of the foreign substances flowing into the sealing device 500 from entering the inside of the bearing space portion S₁ through the internal pressure discharging portion P while discharging the pressure in the bearing space portion S₁ to the outside through the internal pressure discharging portion P.

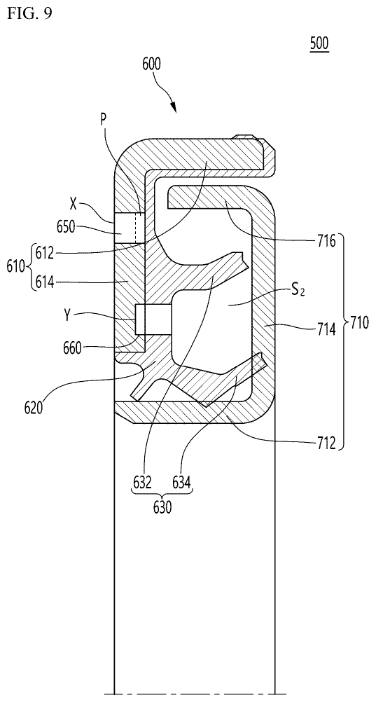

According to an example embodiment of the present disclosure, the first position X communicating with the bearing space port S₁ may be configured to be located further inward in the radial direction than the second position Y communicating with the sealing space port S₂ as shown in FIG. 8 or may be configured to be located further outward in the radial direction than the second position Y communicating with the sealing space port S₂ as shown in FIG. 9.

According to an example embodiment of the present disclosure, as shown in FIG. 9, the sealing device 500 may be configured to comprise at least one sealing lip 632, 634 on the radially outer and radially inner sides of the second position Y in communication with the sealing space portion S₂, respectively. As such, in the case in which the sealing lip 632 is provided on the radially outer side of the second position Y in communication with the sealing space portion S₂, it is preferable that the sealing lip 632 is formed as a non-contact sealing lip or a contact sealing lip which has a relatively small amount of interference compared to the sealing lip 634 located on the radial inner side.

According to an example embodiment of the present disclosure, other configurations may be substantially the same as or may be formed in a similar manner to the example embodiment described above, so detailed description thereof will be omitted.

On the other hand, it should be understood that the technical configuration provided in one example embodiment of the plurality of example embodiments described above can be easily applied and implemented in another example embodiment unless there are special circumstances.

Although the present disclosure has been explained above by specific details such as specific components and limited examples, these examples are provided only to facilitate a more general understanding of the present disclosure, and the present disclosure is not limited to this. In addition, anyone with ordinary knowledge in the technical field to which the present disclosure pertains can make various modifications and changes from this description.

Therefore, the idea of the present disclosure should not be limited to the embodiments described above, and the claims described later as well as all equivalent or equivalent modifications to this claim are included in the scope of the idea of the present disclosure. It will be said that it belongs.

### EXPLANATION OF REFERENCE NUMERALS

100: Vehicular wheel bearing
200: Rotating element
210: Wheel hub
220: Inner ring
300: Non-rotating element
400: Rolling element
500: Sealing device
600: First member (of sealing device)
610: Frame (of first member)
620: Elastic sealing portion
630: Sealing lip
640: Through hole
650: Through hole
660: Recess portion
700: Second member (of sealing device)
710: Frame (of second member)
800: Negative pressure prevention member
P: Internal pressure discharging portion
S₁: Bearing space portion
S2: Sealing space portion

What is claimed is:

1. A vehicular wheel bearing (100) for rotatably mounting and supporting a vehicular wheel on a vehicle body, the vehicular wheel bearing comprising:
a rotating element (200) which rotates together with the vehicular wheel;
a non-rotating element (300) mounted and fixed to the vehicle body;
a plurality of rolling elements (400) disposed between the rotating element (200) and the non-rotating element (300); and
a sealing device (500) installed between the rotating element (200) and the non-rotating element (300) to prevent an inflow of external foreign substances,
wherein the sealing device (500) comprises a first member (600) mounted to either the rotating element (200) or the non-rotating element (300) of the wheel bearing (100); a second member (700) mounted to the other one of the rotating element (200) and the non-rotating element (300) of the wheel bearing (100); and a negative pressure prevention member (800) attached to the first member (600),
the first member (600) of the sealing device (500) comprises a through hole(s) (940) which communicates with a sealing space portion S₂ formed inside the sealing device (500),
the negative pressure prevention member (800) comprises an internal pressure discharging portion P which communicates a bearing space portion S₁, in which the rolling elements (400) are located, with the sealing space portion S₂, and
the inner pressure discharge portion P is configured to communicate with the bearing space portion S₁ at a first position X and to communicate with the sealing space portion S₂ via the through hole(s) (640) at a second position Y apart from the first position X.

2. The vehicular wheel bearing of claim 1, wherein the first position X is located further inward in a radial direction than the second position Y.

3. The vehicular wheel bearing of claim 2, wherein the first position X is located further outward in the radial direction than the second position Y.

4. The vehicular wheel bearing of claim 3, wherein at least one sealing lip is provided on radially outer and radially inner sides of the second position Y, respectively.

5. The vehicular wheel bearing of claim 4, wherein a sealing lip (632) located on the radially outer side of the second position Y is a non-contact sealing lip.

6. The vehicular wheel bearing of claim 1, wherein the internal pressure discharging portion P is formed as a recessed structure in one axial end surface of the negative pressure prevention member (800).

7. The vehicular wheel bearing of claim 6, wherein the internal pressure discharging portion P comprises a plurality of segments extending in different directions to form a labyrinth structure.

8. The vehicular wheel bearing of claim 6, wherein a plurality of the internal pressure discharging portions P are provided in the negative pressure prevention member (800).

9. A vehicular wheel bearing (100) for rotatably mounting and supporting a vehicular wheel to a vehicle body, the vehicular wheel bearing comprising:
a rotating element (200) which rotates together with the vehicular wheel;
a non-rotating element (300) mounted and fixed to the vehicle body;
a plurality of rolling elements (400) disposed between the rotating element (200) and the non-rotating element (300); and
a sealing device (500) installed between the rotating element (200) and the non-rotating element (300) to prevent an inflow of external foreign substances,
wherein the sealing device (500) comprises a first member (600) mounted to either the rotating element (200) or the non-rotating element (300) of the wheel bearing (100); and a second member (700) mounted to the other one of the rotating element (200) and the non-rotating element (300) of the wheel bearing (100),
the first member (600) of the sealing device (500) comprises an internal pressure discharging portion P which communicates a sealing space portion S₂ formed inside the sealing device (500) with a bearing space portion S₁ in which the rolling elements (400) are located, and
the internal pressure discharging portion P is configured to communicate with the bearing space portion S₁ at a first position X and to communicate with the sealing space portion S₂ at a second position Y apart from the first position X.

10. The vehicular wheel bearing of claim 9, wherein the first position X is located further inward in a radial direction than the second position Y.

11. The vehicular wheel bearing of claim 9, wherein the first position X is located further outward in a radial direction than the second position Y.

12. The vehicular wheel bearing of claim 11, wherein at least one sealing lip is provided on radially outer and radially inner sides of the second position Y, respectively.

13. The vehicular wheel bearing of claim 11, wherein a sealing lip (632) located on the radially outer side of the second position Y is a non-contact sealing lip.

14. The vehicular wheel bearing of claim 10, wherein the internal pressure discharging portion P is formed as a recess structure on one axial end surface of a frame (610) of the first member (600) of the sealing device (500).

15. The vehicular wheel bearing of claim 14, wherein the internal pressure discharging portion P comprises a plurality of segments extending in different directions to form a labyrinth structure.

16. The vehicular wheel bearing of claim 14, wherein a plurality of the internal pressure discharging portions P are provided in the first member (600) of the sealing device (500).
